(19) United States
(12) Patent Application Publication
(10) Pub. No.: US 2020/0380596 A1
(43) Pub. Date: Dec. 3, 2020

(54) PERSONAL FINANCIAL MANAGEMENT AND ALERT TOOL

(71) Applicant: Wells Fargo Bank, N.A., San Francisco, CA (US)

(72) Inventors: Gilberto Lopez, Palo Alto, CA (US); Leslie Rae Witt, Mountain View, CA (US); Urmila Raghavan, San Francisco, CA (US); Gregory K. Morishige, San Francisco, CA (US); Karen Yu, San Francisco, CA (US); Michele Armosino, San Francisco, CA (US); Jonathan Velline, Oakland, CA (US)

(21) Appl. No.: 14/593,730

(22) Filed: Jan. 9, 2015

Related U.S. Application Data
(60) Provisional application No. 62/036,329, filed on Aug. 12, 2014.

(51) Int. Cl. G06Q 40/02; G06Q 20/34

(52) U.S. Cl. CPC G06Q 40/02; G06Q 20/34

(57) ABSTRACT

A personal financial notification device includes a processor coupled to machine readable storage media having instructions stored therein. The instructions, when executed by the processor, cause the processor to receive a non-confidential status of a financial account of a user from a separate mobile device. The financial account is associated with the personal financial notification device. The instructions also cause the processor to display the non-confidential status of the financial account without requiring user authentication.

### CROSS-REFERENCE TO RELATED PATENT APPLICATIONS

This application claims priority from U.S. Provisional Application No. 62/036,329, filed Aug. 12, 2014, incorporated herein by reference in its entirety.

### BACKGROUND

The present disclosure relates generally to financial management and, more specifically, to a personal financial management and alert tool.

Individuals often rely on computer-based systems to manage their personal finances. Conventional personal financial management systems include software and internet-based systems. Certain systems allow users to create budgets and goals, and to categorize transactions into various categories. However, many systems are cumbersome and difficult to use. For example, conventional systems require a user to log into a website of a financial institution to determine a status of a budget or goal. Certain users log into such a website on an infrequent basis. Therefore, users are often unaware of budget or goal statuses at any given time, such as while shopping.

### SUMMARY

One embodiment relates to a personal financial notification device. The personal financial notification device includes a processor coupled to machine readable storage media having instructions stored therein. The instructions, when executed by the processor, cause the processor to receive a non-confidential status of a financial account of a user from a separate mobile device. The financial account is associated with the personal financial notification device. The instructions also cause the processor to display the non-confidential status of the financial account without requiring user authentication.

Another embodiment relates to a computer-implemented method of remotely configuring a personal financial notification device. Account information associated with a financial account of a user is received by a processor of a banking system. In addition, a first status relating to the financial account is determined by the processor. Further, confidential information from the first status is removed by the processor to generate a first non-confidential status. Further yet, the non-confidential status is transmitted to the personal financial notification device by the processor. The personal financial notification device is to display the non-confidential status without requiring user authentication.

Another embodiment relates to a mobile device. The mobile device includes a processor coupled to machine readable storage media having instructions stored therein. The instructions, when executed by the processor, cause the processor to receive a non-confidential status of a financial account of a user. The instructions also cause the processor to transmit the non-confidential status to a separate personal financial notification device. The personal financial notification device is to display the non-confidential status without requiring user authentication.

### BRIEF DESCRIPTION OF THE DRAWINGS

FIG. 1 is a block diagram of a data processing system according to an example embodiment.

FIG. 2A is a block diagram of a mobile device according to an example embodiment.

FIG. 2B is a block diagram of a personal financial notification device according to an example embodiment.

FIG. 3 is a flow diagram of a method of remotely configuring a personal financial notification device according to an example embodiment.

FIG. 4 is a flow diagram of a method of remotely configuring a personal financial notification device according to another example embodiment.

FIGS. 5-6 illustrate personal financial notification devices having various displays according to various example embodiments.

FIGS. 7A-7E illustrate various displays of a personal financial notification device according to various example embodiments.

### DETAILED DESCRIPTION

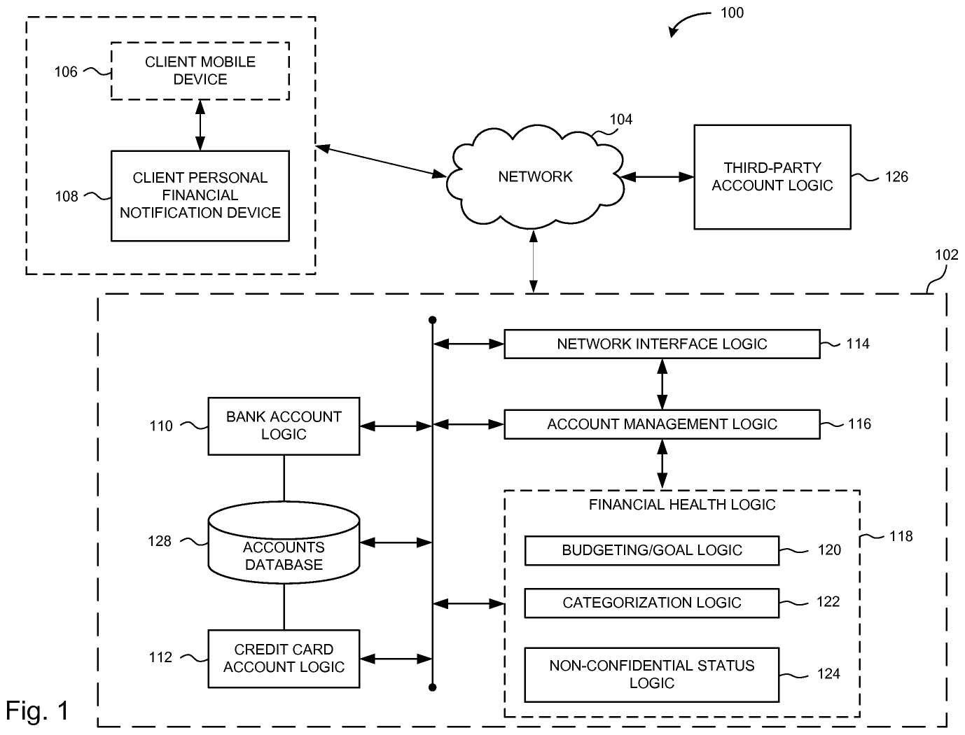

FIG. 1 is a block diagram illustrating a data processing system 100 according to an example embodiment. The data processing system 100 includes a financial management system 102 configured to, among other things, manage personal financial accounts at one or more financial institutions. In the example of FIG. 1, the financial management system 102 is implemented by an enterprise computing system of a financial institution at which a user has one or more financial accounts.

The user may access the financial management system 102 via a network 104 (e.g., the Internet or an intranet) using a client mobile device 106 (“mobile device,” e.g., a laptop computer, tablet computer, PDA, smartphone, portable media device, wearable device, augmented reality device, etc.) or in another manner. In one embodiment, the user may, for example, access the financial management system 102 through an online banking area of a website or application provided by the bank based on a valid username and password. Upon entering the online banking area of the website or application, the user may be provided with profile information, such as one or more partial bank account numbers of the account or the accounts held by the user at the financial institution providing the financial management system 102.

According to various example embodiments, the user may also access the financial management system 102 via the network 104 using a client personal financial notification device 108 (“notification device”). The notification device 108 may receive and display various types of information (e.g., account information, account status, budget status, goal status, notifications, etc.). According to various embodiments, the notification device 108 may be integral to the mobile device 106. However, in other embodiments, the notification device 108 may be separate and distinct from the mobile device 106. In some examples, the notification device 108 receives information directly from the financial management system 102 via the network 104. In other examples, the mobile device 106 receives information from the financial management system 102 via the network 104, and transmits the information to the notification device 108.

The financial management system 102 may include, among other logics, bank account logic 110; credit card account logic 112; network interface logic 114; account management logic 116; and financial health logic 118, including budgeting/goal logic 120, categorization logic 122, and non-confidential status logic 124. Such logics and other logics discussed herein may, in practice, be implemented in a machine (e.g., one or more computers or servers) comprising machine-readable storage media (e.g., cache, memory, internal or external hard drive or in a cloud computing environment) having instructions stored therein which are executed by the machine to perform the operations described herein. For example, the financial management system 102 may include server-based computing systems, for example, comprising one or more networked computer servers that are programmed to perform the operations described herein. In another example, the financial management system 102 may be implemented as a distributed computer system where each function is spread over multiple computer systems.

Network interface logic 114 may be used to connect the financial management system 102 to the Internet to permit users to access the financial management system 102, for example, through an online banking website or other website, through an application, through a display on at least one of the mobile device 106 and the notification device 108, or in other ways. For example, the network interface logic 114 may comprise one or more computers or web servers that provide a graphical user interface (e.g., a series of dynamically-generated web pages) for users that access the financial management system 102 through the web. The graphical user interface may be used to prompt the user to provide login information, passwords, or other authentication information or other stored tokens. Upon successfully logging in, the graphical user interface may be used to provide the user with current (e.g., real-time or near real-time) account information. In other examples, the network interface logic 114 may provide non-confidential information (e.g., current account status, goal status, budget status, notifications, etc.) to at least one of the mobile device 106 and the notification device 108 without requiring the user to provide login information, passwords and other authentication information or other stored tokens. The network interface logic 114 may also comprise other logic that is configured to provide an interface for other types of devices such as mobile devices (e.g., cellular phones, smart phones, tablet computers, mobile e-mail devices, etc.), fax machines, ATMs, server-based computing systems, etc. The network interface logic 114 may provide access to an application programming interface (API) for various third-party networks such as Mint®, Facebook®, LinkedIn®, EWise®, Yodlee®, etc. The network interface logic 114 may also be used to connect to third-party account logic 126 to provide access to users' accounts (e.g., bank accounts, brokerage accounts, credit card accounts, social media accounts, etc.) managed by third-parties that are external to the financial management system 102.

The account management logic 116 may interact with various backend systems in connection with maintaining financial accounts for account owners. For example, the account management logic 116 may manage bank accounts (e.g., checking and savings accounts) via bank account logic 110 and credit card accounts via credit card account logic 112. The bank account logic 110 and credit card account logic 112 may store account information for various users' accounts in one or more accounts databases 130. The account management logic 116 manages each user's accounts by facilitating, among other things, account processing, account records, statement generation, bill pay, funds transfers, etc. Account records include, among other things, records of financial transactions associated with each account. Financial transactions may include, for example, credits or debits to a user's account, such as the purchase of a good or the deposit of a paycheck, and various metadata associated therewith.

In addition to the above, the account management logic 116 provides enhanced functionality to users by utilizing financial health logic 118, including budgeting/goal logic 120, categorization logic 122, and non-confidential status logic 124. As explained in further detail below, the financial health logic 118 is configured to engage users and improve their overall financial health by providing easily accessible status updates and notifications regarding the users' financial accounts, budgets, and/or goals.

Budgeting/goal logic 120 allows users to track various financial budgets and goals. According to some examples, the budgeting/goal logic 120 allows users to input budget and/or goal parameters to set various budgets and/or goals. In other examples, the budgeting/goal logic 120 analyzes information about a user (e.g., information received via account management logic 116) to suggest and/or to set various budgets and goals. For example, the budgeting/goal logic 120 may determine that a user has a certain amount of credit card debt. In this example, the budgeting/goal logic 120 may set a goal for the user to pay off his or her credit card debt.

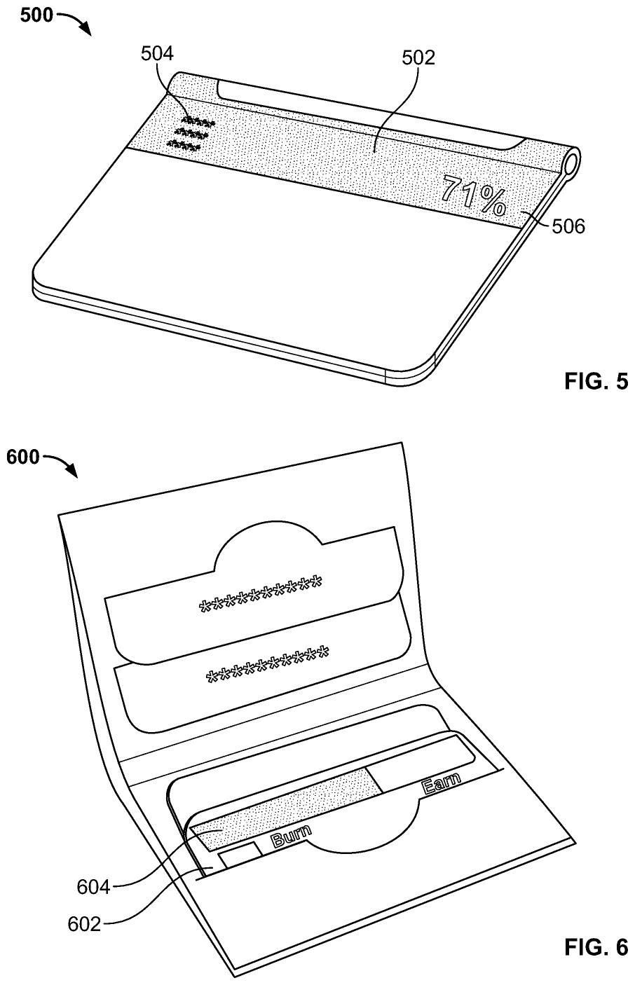

Budgeting/goal logic 120 also displays users' budget and/or goal status in various ways. In one example, the budgeting/goal logic 120 displays budget and/or goal status via graphical indicators, such as images of a thermometer or meter. In some examples, the graphical indicator is filled in or colored in proportion to the user's progress towards the corresponding budget or goal. Example user interfaces discussed below in connection with FIGS. 5-6 further illustrate examples of how the budgeting/goal logic 120, in connection with the categorization logic 122 and the non-confidential status logic 124, may display various budgets and/or goals.

Categorization logic 122 categorizes transactions within various budget and/or goal categories. In some embodiments, the categorization logic 122 facilitates manual transaction categorization by a user. In other embodiments, the categorization logic 122 automatically “pre-categorizes” or “suggests” categorization based on a user's prior usage or categorization history, or based on other parameters (e.g., merchant, merchant category, amount, anonymized data, etc.). In further embodiments, the categorization logic 122 automatically categorizes transactions, which a user may later re-categorize if he or she disagrees with the automatic categorization. The categorization logic 122 is configured to “learn” from users' categorization history, transaction history, and corresponding patterns or habits to optimize subsequent automatic categorization or “pre-categorization.” According to various examples, the budgeting/goal logic 120 leverages the categorization logic 122 to track users' budget and/or goal status for various categories (e.g., dining, entertainment, transportation, etc.).

Non-confidential status logic 124 provides non-confidential information (e.g., account status, budget status, goal status, notifications, etc.) to at least one of the mobile device 106 and the notification device 108. In some examples, the non-confidential status logic 124 provides non-confidential information without first requiring the user to provide login information, passwords, or other authentication information or other stored tokens. In some embodiments, users must first enroll in a program (e.g., a program managed by the financial management system 102) in order to opt-in to receiving non-confidential information on at least one of the mobile device 106 and the notification device 108. Confidentiality and privacy are inherently personal topics; what may be considered confidential by one user may be considered non-confidential by another user. Therefore, in certain examples, the non-confidential status logic 124 allows a user to define the content comprising the non-confidential information. In some embodiments, users may further define various aspects relating to the non-confidential information, such as an origin of the non-confidential information (e.g., a particular budget or goal status, a particular account balance, etc.), a layout configuration according to which the non-confidential information is to be displayed, a period relating to the non-confidential information (e.g., day, week, month, year, etc.), a frequency at which the non-confidential information is to be updated (e.g., continuously (e.g., in real-time or near real-time), hourly, daily, weekly, etc.), among other aspects. According to various example embodiments, confidential information includes any type of information that a user would not want a third-party to see without prior authorization from the user. For example, confidential information includes account numbers, account balances, dollar amounts relating to budgets or goals, personal identification information (e.g., the user's name, address, Social Security Number, etc.), or any other information that a particular user deems confidential.

According to various example embodiments, the non-confidential status logic 124 removes confidential information and/or replaces confidential information with non-confidential information. In one example, the non-confidential status logic 124 removes confidential information such as absolute values (e.g., dollar amounts) associated with account balances, goal or budget statuses, etc., and instead provides such information in relative terms. For example, such information may be graphically displayed as meters or other images that are sized, colored, or darkened in proportion to corresponding amounts. For example, instead of providing that a user has spent $400 of his or her $500 restaurant budget for the month, the non-confidential status logic 124 may provide a non-confidential form of the same information by providing that the user has spent 80% of his or her restaurant budget for the month. In one embodiment, 80% may be displayed as text, whereas in another embodiment, 80% may be displayed graphically.

In some embodiments, the non-confidential status logic 124 (e.g., via the network interface logic 114) provides the non-confidential information directly to the notification device 108. In other embodiments, the non-confidential status logic 124 (e.g., via the network interface logic 114) provides the non-confidential information to the mobile device 106. The mobile device 106 may display the non-confidential information and/or may transmit the non-confidential information to the notification device 108.

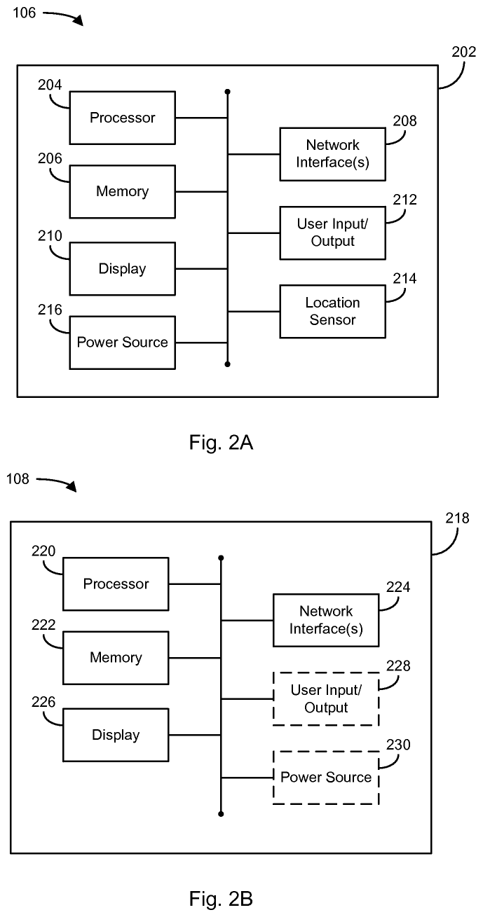

Referring to FIG. 2A, a block diagram of the mobile device 106 of FIG. 1 is shown according to an example embodiment. According to various example embodiments, the mobile device 106 is a laptop computer, tablet computer, PDA, smartphone, portable media device, wearable device, augmented reality device, etc. The mobile device 106 includes a housing 202. The housing 202 is coupled to the various electrical components of the mobile device 106. The mobile device 106 also includes a processor 204 and memory 206. The memory 206 includes program modules that, when executed by the processor 204, control the operation of the mobile device 106. The memory 206 may also store various applications, such as an application of the financial institution that facilitates communication between the mobile device 106 and the various computing systems of the financial management system 102. The memory 206 may include any combination of RAM, ROM, NVRAM, etc.

The mobile device 106 also includes at least one network interface 208. In one example, the network interface 208 is a wireless network interface. The network interface 208 includes any of a cellular transceiver (e.g., CDMA, GSM, LTE, etc.), a wireless network transceiver (e.g., 802.11X, Bluetooth, NFC, Bluetooth Low Energy (BLE), RFID, ZigBee, etc.), or a combination thereof (e.g., both a cellular transceiver and a Bluetooth transceiver). The network interface 208 is capable of communicating with the notification device 108 (e.g., via 802.11x, Bluetooth, BLE, NFC, RFID, etc.). Additionally, the network interface 208 is capable of communicating with the financial management system 102 via the network interface logic 114 over the network 104 (e.g., via the Internet as accessed through a cellular data network).

The mobile device 106 also includes a display 210 and a user input/output 212. In some examples, the display 210 and the user input/output are combined (e.g., as a touchscreen display device). In other examples, the display 210 and the user input/output 212 are discrete devices. The user input/output 212 includes any of touchscreen displays, buttons, speakers, keyboards, notification LEDs, microphones, biometric sensors (e.g., fingerprint scanners), switches, cameras, or a combination thereof.

In some examples, the mobile device 106 includes a location sensor 214 (e.g., a GPS device) for determining the location of the mobile device 106. The mobile device 106 also includes a power source 216. The power source 216 may include any combination of grid power and battery power (e.g., alkaline batteries, lithium batteries, rechargeable batteries, etc.). In examples where the power source 216 is a rechargeable battery, the mobile device 106 also includes the circuitry necessary to recharge the battery.

Referring to FIG. 2B, a block diagram of the notification device 108 is shown according to an example embodiment. In some examples, the notification device 108 is integral to the mobile device 106. However, in other examples, the notification device 108 is separate and distinct from the mobile device 106. In some examples, the notification device 108 is configured as a smart card, which may be shaped and sized similar to a conventional credit card. In one example, the notification device 108 is smaller than 90 millimeters×60 millimeters×1 millimeter. In one example, the notification device 108 weighs less than 50 grams. In another example, the notification device 108 weighs less than 10 grams. The notification device 108 is discussed below with respect to a smart card form factor. However, other examples may utilize any shape or configuration. In some examples, the notification is not capable of at least one of accepting text input, wirelessly transmitting voice data received from the user, establishing a telephone connection, and executing any other applications. In some examples, the notification device 108 does not include a built-in camera.

The notification device 108 includes a housing 218. The housing 218 is coupled to the various electrical components of the notification device 108. The notification device 108 also includes a processor 220 and memory 222. The memory 222 includes program modules that, when executed by the processor 220, control the operation of the notification device 108. The memory 222 may also store various applications, such as an application of the financial institution that facilitates communication between the notification device 108 and the various computing systems of the financial management system 102. The memory 222 may include any combination of RAM, ROM, NVRAM, etc.

The notification device 108 includes at least one network interface 224. The network interface 224 is a wireless network interface. The network interface 224 includes a wireless network transceiver (e.g., 802.11X, Bluetooth, BLE, NFC, RFID, ZigBee, etc.). The network interface 208 is capable of communicating with the notification device 108 (e.g., via 802.11x, Bluetooth, BLE, NFC, RFID, etc.). In some embodiments, the network interface 224 is capable of communicating directly with the financial management system 102 via the network interface logic 114 over the network 104 (e.g., via the Internet as accessed through an 802.11X network).

In some examples, the notification device 108 may be paired with at least one of the financial management system 102 (e.g., via the network interface logic 114 and the account management logic 116 of the financial management system 102) and the mobile device 106 to facilitate communication between the notification device 108 and at least one of the financial management system 102 and the mobile device 106, respectively.

The notification device 108 may be paired with the mobile device 106 in various ways. For example, upon the user logging into a banking website or application through the mobile device 106, the notification device 108 may be paired with the mobile device 106 by entering a serial number of the notification device 108 into the banking website or application. In some examples, the mobile device 106 may also be linked to the user's account by entering a serial number of the mobile device 106 into the banking website or application. In another example, the notification device 108 may be paired with the mobile device 106 by the mobile device 106 scanning an item (e.g., a quick response (QR) code or a barcode) on the notification device 108. In other examples, the notification device 108 may be paired with the mobile device 106 through various wireless pairing mechanisms, for example, pairing mechanisms utilizing at least one of Bluetooth, BLE, and NFC. In one example, upon enrolling in a program to opt-in to receiving non-confidential information, the financial institution associated with the financial management system 102 pairs the notification device 108 with the user's account and provides the paired notification device 108 to the user.

Upon pairing the notification device 108 with the mobile device 106, information may be communicated between the notification device 108 and the mobile device 106 in various ways. In one example, communication is triggered based on a specific request from one of the notification device 108 and the mobile device 106, such as by selecting an “Update” button via the user input/output 228 of the notification device 108. In another example, communication is triggered automatically upon the notification device 108 being within a particular range of the mobile device 106. In some examples, non-confidential information is automatically transmitted to the notification device 108 from the mobile device 106 without requiring additional authentication upon the devices being within a particular range of each other. In other examples, a user may be prompted to enter a personal identification number (PIN) onto one of the mobile device 106 and the notification device 108 prior to information being transmitted therebetween. In some examples, confidential information, in addition to non-confidential information, is transmitted to the notification device 108 from the mobile device 106 upon the user entering a PIN. According to various embodiments, information is communicated between the notification device 108 and the mobile device 106 on a periodic basis (e.g., every minute, every hour, every day, etc.). In some examples, the particular frequency at which the information is communicated may be configurable by the user. In other examples, the information is “pushed” to the notification device 108 from the mobile device 106 whenever the information changes (e.g., whenever a balance or status relating to the user's account is changed).

The notification device 108 includes a display 226. In some examples, the display 210 is a bi-state display, such as electronic paper (e.g., electrophoretic ink (e-Ink) or Gyricon®). Bi-state displays require power to change the display content but typically do not require power to retain the existing display content. In other words, in examples in which the display 210 is a bi-state display, the display 210 will stay in the state in which it was written until power and data are subsequently applied. In other examples, the display 210 includes a liquid crystal display (LCD), a light-emitting diode display (LED), or other types of display technologies, which require power to operate.

In some examples, the notification device 108 also includes user input/output 228. In some examples, the display 226 and the user input/output 228 are combined (e.g., as a touchscreen display device). In other examples, the display 226 and the user input/output 228 are discrete devices. The user input/output 228 includes any of touchscreen displays, buttons, notification LEDs, biometric sensors (e.g., fingerprint scanners), or a combination thereof. For example, the user input/output 228 may include buttons to allow a user to manually provide information (e.g., a PIN) to the notification device 108 or to allow a user to change the items shown on the display 226. For example, in some embodiments, a user may scroll through various goals or budgets shown on the display 226 via the user input/output. In some examples, the notification device 108 is not capable of receiving text input via the user input/output 228.

In some example embodiments, the notification device 108 also includes a power source 230. The power source 230 may include any combination of grid power and battery power (e.g., alkaline batteries, lithium batteries, rechargeable batteries, etc.). In examples where the power source 230 is a rechargeable battery, the notification device 108 also includes the necessary circuitry to recharge the battery.

In other example embodiments, the power source 230 is external to the notification device 108. For example, in some embodiments, the notification device receives power wirelessly, e.g., from the mobile device 106. For example, in one implementation, the display 226 is an electronic paper display and the network interface 224 includes NFC capabilities. In this implementation, the notification device 108 receives both power and data (e.g., a non-confidential status) via NFC circuitry of the network interface 224, which may be transmitted to the notification device 108 from the mobile device 106. Because electronic paper displays require power only to change the state of the display, the notification device 108 does not require an internal power source 230. Instead, the power source 230 is external to the notification device 108 (e.g., within the mobile device 106) in certain implementations.

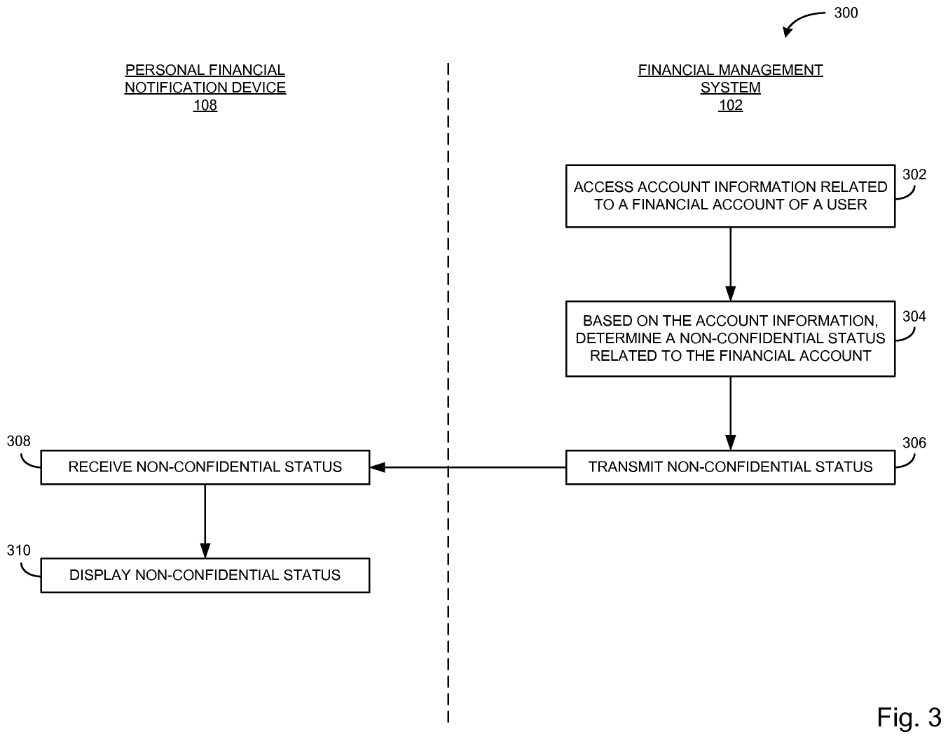

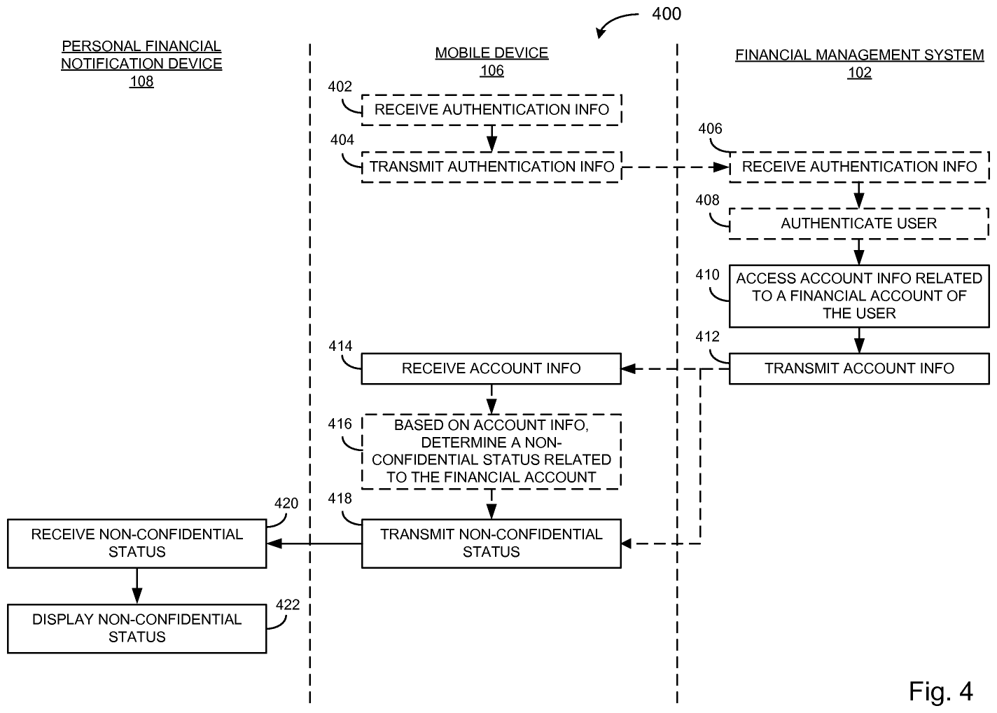

Turning to FIGS. 3 and 4, flow diagrams of methods 300, 400 of remotely configuring a personal financial notification device are illustrated according to example embodiments. For the purposes of clarity and brevity, the methods 300, 400 are described with respect to the financial management system 102 of FIG. 1, as well as the mobile device 106 and the notification device 108 of FIGS. 1 and 2. However, the methods 300, 400 may be performed by other devices. The method 300 of FIG. 3 illustrates an example embodiment in which the notification device 108 (left-most column) receives information directly from the financial management system 102 (right-most column). The method 400 of FIG. 4, illustrates another example embodiment in which the mobile device 106 (center column) receives information from the financial management system 102 (right-most column), and the mobile device 106 (center column) subsequently transmits the information to the notification device 108 (left-most column). In various embodiments, the notification device 108 has been paired with the financial management system 102 prior to performing the methods 300, 400.

Referring to FIG. 3, at 302, account information associated with a financial account of a user is accessed. In one example, the account management logic 116 interfaces with the bank account logic 110 to access account information associated with a bank account (e.g., checking account and/or savings account) of the user, which may be stored in the accounts database 130. Similarly, if the user has a credit card account, the account management logic 116 interfaces with the credit card account logic 112 to access account information associated with the user's credit card account, which may also be stored in the accounts database 130. In some examples, the account management logic 116 also interfaces with the budgeting/goal logic 120 to receive information associated with one or more budgets and/or financial goals associated with one or more financial accounts of the user.

At 304, a non-confidential status related to the financial account is determined based on the account information received at 302. According to an example embodiment, the non-confidential status may be determined by the non-confidential status logic 124. The non-confidential status may include any information related to the financial account of the user, such as an account balance, balances of various budget categories within the account, progress towards a financial goal related to the account, etc. The non-confidential status may include financial information in which confidential information has been removed or replaced with non-confidential information. For example, as mentioned above, confidential information may include account numbers, account balances, dollar amounts relating to budgets or goals, personal identification information (e.g., the user's name, address, Social Security Number, etc.), or any other information. In one example, the non-confidential status logic 124 removes confidential information such as absolute values (e.g., dollar amounts) associated with account balances, goal or budget statuses, etc., and instead provides such information in relative terms. For example, such information may be graphically displayed as a meter or other image that is sized or colored in proportion to a corresponding amount.

At 306, the non-confidential status is transmitted from the financial management system 102 (e.g., from the non-confidential status logic 124 of the financial management system 102) to the notification device 108. At 308, the non-confidential status is received by the notification device 108. According to an example embodiment, the financial management system 102 (e.g., via the network interface logic 114) transmits the non-confidential status over the network 104 to the notification device 108 (e.g., via the network interface 224). In certain examples, the non-confidential status is transmitted via wireless (e.g., 802.11X, Bluetooth, BLE, NFC, RFID, ZigBee, etc.) communications.

At 310, the non-confidential status is displayed on the notification device 108. According to various embodiments, the non-confidential status may be displayed in various ways, such as numerically and/or graphically.

Turning to FIG. 4, a method 400 of remotely configuring a personal financial notification device is illustrated according to an example embodiment. In the example embodiment of FIG. 4, the mobile device 106 (center column) receives information from the financial management system 102 (right-most column), and the mobile device 106 (center column) subsequently transmits the information to the notification device 108 (left-most column).

According to various examples, information is transmitted from the financial management system 102 to the mobile device 106, and from the mobile device 106 to the notification device 108 in different ways. In some examples, information is transmitted from the financial management system 102 to the mobile device 106 automatically. For example, information may be transmitted periodically (e.g., once a week). In other examples, information may be transmitted based on a trigger, such as a budget category exceeding a predetermined threshold, for example. In other examples, information is transmitted from the financial management system 102 to the mobile device 106 based on user input to the mobile device 106.

402-408 are performed in embodiments in which the financial management system 102 receives authentication information from the user prior to the financial management system 102 transmitting account information to the mobile device 106. At 402, the mobile device 106 receives authentication information from a user. For example, the authentication information (e.g., a username, account number, password, PIN, etc.) may be inputted by the user through an online banking website or a banking application displayed on the mobile device 106. At 404, the authentication information is transmitted from the mobile device 106 to the financial management system 102. At 406, the financial management system 102 receives the authentication information from the mobile device 106 and, at 408, the user is authenticated.

At 410, account information associated with a financial account of a user is accessed, as described above in connection with 302. In some embodiments, the account information is accessed upon the user being authenticated at 408. However, in other embodiments, the account information is accessed automatically (e.g., periodically), without requiring authentication and/or user input.

At 412, the account information is transmitted to the mobile device 106. At 414, the account information is received by the mobile device 106. In some examples, the account information transmitted by the financial management system 102 at 412 includes confidential information. In such examples, at 416, the account information is processed by the mobile device 106 to determine a non-confidential status related to the financial account based on the account information. However, in other embodiments, the non-confidential status logic 124 of the financial management system 102 processes the account information such that the account information transmitted at 412 includes the non-confidential status information. In these examples, the account information, including the non-confidential status information, is transmitted to the mobile device 106 at 418.

At 418, the non-confidential status information is transmitted by the mobile device 106 to the notification device 108. According to various example embodiments, information is transmitted from the mobile device 106 to the notification device 108 in different ways. In some examples, information is transmitted from the mobile device 106 to the notification device 108 automatically. For example, information may be transmitted upon the mobile device 106 receiving the information from the financial management system 102 at 414, or on a periodic basis (e.g., once a week). In other examples, information is transmitted based on user input (e.g., a button press) to the notification device 108. In other examples, information is transmitted (e.g., via NFC or BLE) based on proximity of the notification device 108 to the mobile device 106. For example, information can be transmitted from the mobile device 106 to the notification device 108 if the respective devices are less than a predetermined distance apart. In another example, information can be transmitted upon the notification device 108 being “tapped” against the mobile device 106. In some embodiments, upon tapping the notification device 108 against the mobile device 106, the user is prompted to enter a PIN on the mobile device 106 prior to the mobile device 106 transmitting the information at 418 to the notification device 108.

At 420, the non-confidential status information is received by the notification device 108 as described above in connection with 308. At 422, the non-confidential status is displayed on the notification device 108 as described above in connection with 310. In some examples, the non-confidential status is displayed on the notification device 108 without requiring user authentication.

Turning to FIG. 5 a notification device 500 is illustrated according to an example embodiment. The notification device 500 is an example implementation of the notification device 108. As shown in FIG. 5, the notification device 500 is implemented as a smart card. The notification device includes a display 502, which is an example implementation of the display 226 of FIG. 2B. In some examples, the display 502 is an electronic ink display.

The display 502 may be configured to display information relating to financial accounts of a user, such as confidential and/or non-confidential status (e.g., account status, budget status, goal status, etc.) information or other information. For example, as shown in FIG. 5, the display 502 includes a first item 504 and a second item 506. In an example, the first item 504 identifies a particular budget category or goal, and the second item 506 is a non-confidential status relating to the budget category or goal. The display 502 may be updated from time to time as described above in connection with the notification device 108.

Turning to FIG. 6, a notification device 600 is illustrated according to another example embodiment. The notification device 600 is another example implementation of the notification device 108. Similar to the notification device 500 of FIG. 5, the notification device 600 is implemented as a smart card and is illustrated in a wallet along with other credit or debit cards. The notification device also includes a display 602, which may be an electronic ink display.

The display 602 as shown in FIG. 6, illustrates a “burn to earn” ratio, which is an example financial health metric that indicates the amount of disposable income that a user has. The display 602 may be updated from time to time as described above in connection with the notification device 108.

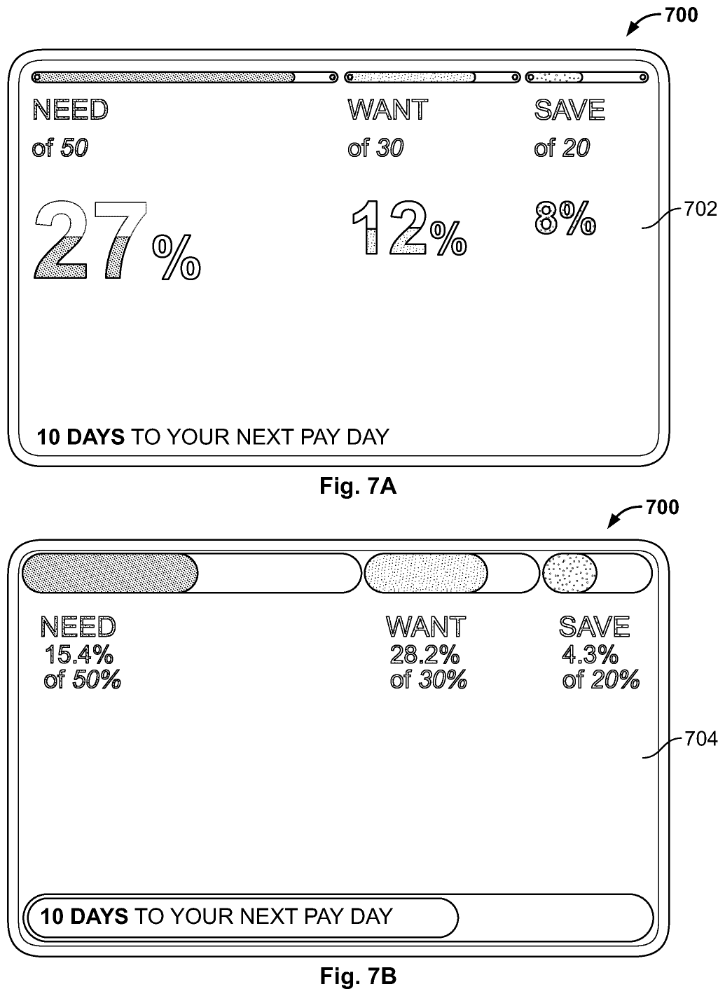

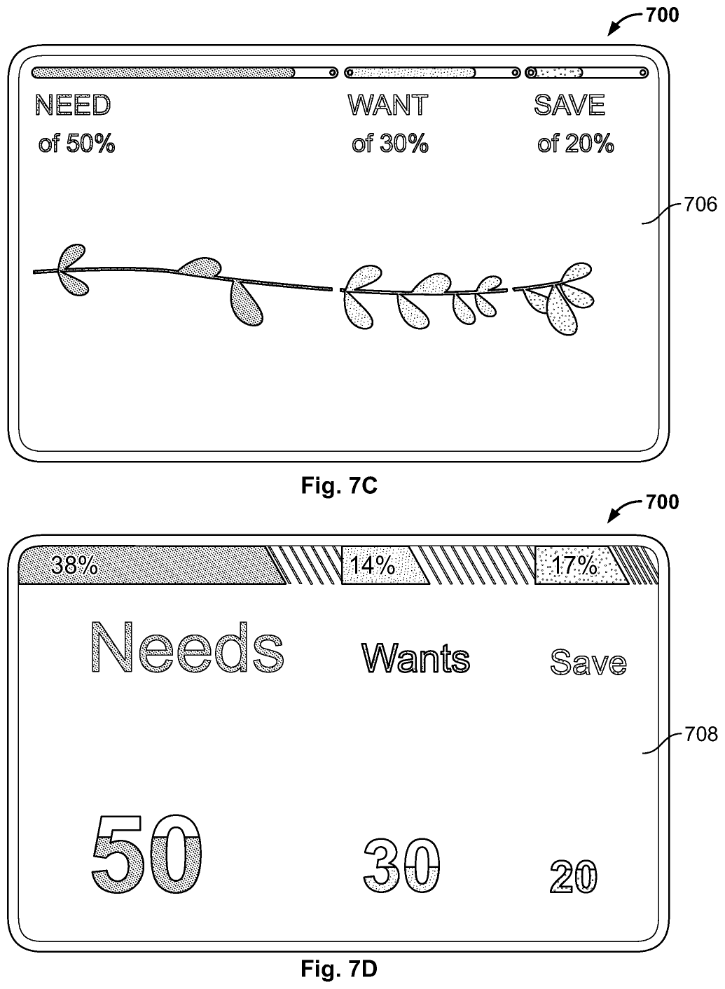

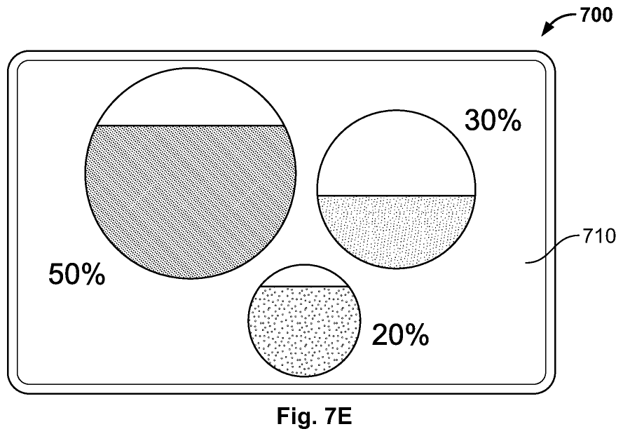

FIGS. 7A-7E illustrate various displays 702, 704, 706, 708, 710 of a notification device 700, according to example embodiments. The notification device 700 is an example implementation of the notification device 108. Additionally, each of the respective displays 702, 704, 706, 708, 710 of FIGS. 7A-7E are example implementations of the display 226. In particular, the displays 702, 704, 706, 708, 710 illustrate various ways of displaying non-confidential statuses according to a “50/30/20 Rule” of personal financial management. The 50/30/20 Rule provides a budget that divides after-tax income, or net pay, into three budget categories: (1) fifty percent for needs; (2) thirty percent for wants; and (3) twenty percent for savings and debt. “Needs” include any expenses an individual cannot forgo in a given month, such as rent, groceries and minimum payments on credit cards, mortgages and auto loans. “Wants” include expenses that are not immediately necessary, such as vacations, gifts, entertainment, clothes, and dining out. Savings and debt includes, for example, paying down credit cards, creating an emergency fund, and saving for retirement. Transactions may be categorized into such budget categories via the categorization logic 122 of FIG. 1. In one embodiment, transactions are categorized as “Needs,” as “Wants,” or as partially “Needs” and partially “Wants.” “Savings” may be determined based on additional remaining cash flow over a time period after categorizing the transactions that occurred over the time period as “Needs” and/or “Wants.”

Turning to FIG. 7A, the notification device 700 of FIG. 7 has a display 702 that provides an overview of a budget, which may be tracked based on periods defined by dates that a user is paid. The display 702 includes a first item 704 and a second item 706. The first item 704 is a visual overview of the amount of each respective budget category that has been attributed to transactions and the amount remaining for a particular time period. For example, the display 702 indicates that 27% of a first budget category (e.g., “Need”), which represents 50% of a total budget amount, has been attributed to transactions. Accordingly, the text of “27%” is darkened according to the percentage of that respective category that has been attributed to transactions. In other words, 27% is slightly more than half of 50%, so the text of “27%” is darkened slightly more than halfway from the bottom. The second item 706 is a message or notification. For example, the second item 706 includes a message relating to the time period associated with the budgets, stating “10 DAYS TO YOUR NEXT PAY DAY.” Other embodiments may include any number of items. In some embodiments, users may define the content and layout of the items that are included on the display 702. In some embodiments, the user can configure the display 702 via a banking website or application. In some embodiments, the user may choose from pre-designed layout templates and/or may design custom layouts. The items included in a layout for a display (e.g., the display 702) need not be related to a user's financial account. For example, some layouts may include stock quotes, news headlines, sports scores, etc.

FIGS. 7B-7E illustrate displays 708, 710, 712, 714, which are alternative embodiments of the display 702 of FIG. 7. In particular, the display 708 of FIG. 7B includes bars for each budget category that are darkened based on amounts of the transactions attributed to the respective budget categories. The display 710 of FIG. 7C illustrates a plant that loses leaves in different areas based on amounts of the transactions attributed to the corresponding budget categories. The display 712 of FIG. 7D illustrates numbers that are darkened based on the amounts of the transactions attributed to the respective budget categories. And the display 714 of FIG. 7E illustrates shapes that are darkened, or filled up, based on the amounts of the transactions attributed to the respective budget categories.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing system in the form of computers, including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

1. A system, comprising:
a mobile device comprising a first processor coupled to a first machine readable storage media having instructions stored therein that, when executed by the first processor, cause the first processor to:
receive account information associated with a financial account of a user;
determine a first status relating to the financial account based on the account information, the first status comprising an absolute value of a balance regarding a category of the financial account and an absolute value of a budget for the category;
generate a non-confidential status based on the first status, the non-confidential status comprising a graphical representation of a relative value determined from the absolute value of the balance and the absolute value of the budget; and
transmit the non-confidential status to a personal financial notification device, the personal financial notification device being separate from the mobile device and comprising a second processor coupled to second machine readable storage media having instructions stored therein that, when executed by the second processor, cause the second processor to:
receive, from the mobile device, the non-confidential status; and
display, without requiring user authentication, a first part of the non-confidential status, wherein the first part of the non-confidential status comprises the graphical representation of the relative value; and
display, based on receiving user authentication information via the personal financial notification device, a graphical representation comprising at least one of the absolute value of the balance or the absolute value of the budget.

2-3. (canceled)

4. The system of claim 1, wherein the non-confidential status is a near-real-time status of the financial account of the user.

5. The system of claim 1, wherein the personal financial notification device includes a Near Field Communication (NFC) device, wherein the personal financial notification device receives the non-confidential status via the NFC device.

6. The system of claim 1, wherein the personal financial notification device includes a BLUETOOTH low energy (BLE) device, wherein the personal financial notification device receives the non-confidential status via the BLE device.

7. The system of claim 1, wherein the personal financial notification device includes an electronic paper display.

8. The system of claim 1, wherein the personal financial notification device is powered by solely by energy received wirelessly from the separate mobile device.

9. The system of claim 8, wherein the electronic paper display is configured to display the non-confidential status using the energy received from the separate mobile device, wherein the displayed non-confidential status is maintained on the electronic paper display when the energy received from the separate mobile device is discontinued.

10. The system of claim 1, wherein the personal financial notification device is powered by an internal battery.

11. The system of claim 1, wherein the personal financial notification device is not capable of accepting text input.

12. The system of claim 1, wherein the personal financial notification device is not capable of wirelessly transmitting voice data received from the user.

13. The system of claim 1, wherein the personal financial notification device is not capable of establishing a telephone connection.

14. The system of claim 1, wherein the personal financial notification device has no built-in camera.

15. The system of claim 1, wherein the personal financial notification device does not execute any other applications.

16. The system of claim 1, wherein the personal financial notification device has a credit card form factor.

17. The system of claim 1, wherein the personal financial notification device is smaller than 90 millimeters×60 millimeters×1 millimeter.

18. The system of claim 1, wherein the personal financial notification device weighs less than 50 grams.

19. The system of claim 1, wherein the personal financial notification device weighs less than 10 grams.

20-32. (canceled)

33. A mobile device comprising a first processor coupled to a first machine readable storage media having instructions stored therein that, when executed by the first processor, cause the first processor to:
receive account information associated with a financial account of a user;
determine a first status relating to the financial account based on the account information, the first status comprising an absolute value of a balance regarding a category of the financial account and an absolute value of a budget for the category;
generate a non-confidential status based on the first status, the non-confidential status comprising a graphical representation of a relative value determined from the absolute value of the balance and the absolute value of the budget; and
transmit the non-confidential status to a separate personal financial notification device, the personal financial notification device configured to display the graphical representation of the relative value without requiring user authentication.

34. The mobile device of claim 33, wherein the mobile device transmits the non-confidential status upon receiving a request from the personal financial notification device.

35. The mobile device of claim 33, wherein the instructions further cause the first processor to detect that the personal financial notification device is within a pre-determined range of the mobile device, wherein the mobile device transmits the non-confidential status upon detecting that the personal financial notification device is within the pre-determined range.

36. The mobile device of claim 33, wherein the mobile device transmits the non-confidential status via a wireless network interface.

37. The mobile device of claim 36, wherein the wireless network interface includes a Near Field Communication (NFC) device.

38. The mobile device of claim 37, wherein the instructions further cause the processor to transmit energy to the personal financial notification device via the NFC device.

39. The mobile device of claim 38, wherein the wireless network interface includes a BLUETOOTH low energy (BLE) device.

40. The mobile device of claim 33, wherein the non-confidential status includes a balance of the financial account.

41. The mobile device of claim 40, wherein the balance includes balances of each of a plurality of budget categories of the financial account.

42. The mobile device of claim 33, wherein the non-confidential status includes a goal progress related to the financial account.

43. The mobile device of claim 33, wherein the personal financial mobile device is a smart card.

44. A system, comprising:
a mobile device; and
a personal financial notification device wirelessly coupled to the mobile device;
wherein the mobile device comprises a first processor coupled to a first machine readable storage media having instructions stored therein that, when executed by the first processor, cause the first processor to:
receive account information associated with a financial account of a user;
determine a first status relating to the financial account based on the account information, the first status comprising an absolute value of a balance regarding a category of the financial account and an absolute value of a budget for the category;
generate a non-confidential status based on the first status, the non-confidential status comprising a graphical representation of a relative value determined from the absolute value of the balance and the absolute value of the budget; and
transmit the non-confidential status to the personal financial notification device; and
wherein the personal financial notification device comprises a second processor coupled to a second machine readable storage media having instructions stored therein that, when executed by the second processor, cause the second processor to:
receive from the mobile device, the non-confidential status; and
display, without requiring user authentication, the graphical representation of the relative value.

45. The system of claim 44, wherein the personal financial notification device is a smart card.

46. The system of claim 45, wherein the smart card is sized and shaped similar to a conventional credit card.

47. (canceled)

48. The system of claim 1, wherein the non-confidential status is displayed on the personal financial notification device without further requiring user input.

49. (canceled)

50. The mobile device of claim 33, wherein the non-confidential status is displayed on the personal financial notification device without further requiring user input.

51. (canceled)

52. The system of claim 44, wherein the non-confidential status is displayed on the personal financial notification device without further requiring user input.

53. The system of claim 1, wherein the first status is accessible to the user on the mobile device after the user is authenticated, and wherein the non-confidential status is accessible to the user on the personal financial notification device without the user being authenticated.
